(19) United States
(12) Patent Application Publication
(10) Pub. No.: US 2026/0000558 A1
(43) Pub. Date: Jan. 1, 2026

(54) USER-TRANSFER BENCH SYSTEMS FOR BATHTUBS

(71) Applicant: Alfred Thomas Newman, Ft Myers, FL (US)

(72) Inventor: Alfred Thomas Newman, Ft Myers, FL (US)

(21) Appl. No.: 19/203,831

(22) Filed: May 9, 2025

Related U.S. Application Data
(60) Provisional application No. 63/731,990, filed on Jul. 1, 2024.

(51) Int. Cl. A61G 7/10; A47K 3/12

(52) U.S. Cl. CPC A61G 7/1003; A47K 3/122; A61G 7/1059

(57) ABSTRACT

The present disclosure provides a user-transfer bench system for bathtubs. Further, the user-transfer bench system for bathtubs may include a clamping device which may be configured for securing the user-transfer bench system on a wall of the bathtub. Further, the clamping device may be mechanically fastened to the bathtub. Further, the user-transfer bench system for bathtubs may include a bench which can be straddled like a saddle and configured for facilitating mounting and dismounting actions performed by the user so that the user may safely enter and exit the bathtub. Further, the bench may be mechanically coupled to the clamping device.

### FIELD OF DISCLOSURE

The present invention relates to the field of chairs and seats. More specifically, the present disclosure relates to user-transfer bench systems for bathtubs.

### BACKGROUND

Many people who have difficulty entering and exiting a bathtub use a conventional bathtub transfer bench to position themselves over the bathtub so they can take a shower or wash themselves with a hand-held sprayer. This manner of bathing is not as relaxing as submersing and soaking your body within the bathtub, however conventional bathtub transfer bench systems do not assist users who want to lower themselves into the bathtub; nor do they provide an easy means for users to raise themselves and remount the bench, then safely exit the bathtub. Therefore, there is a need for improved user-transfer bench systems for bathtubs.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a user-transfer bench system for bathtubs. Further, the user-transfer bench system for bathtubs may include a clamping device which may be configured for securing the user-transfer bench system on a bathtub. Further, the clamping device may be mechanically fastened to the bathtub. Further, the user-transfer bench system may include a bench which may be configured for facilitating mounting and dismounting actions performed by the user. Further, the bench may be mechanically coupled to the clamping device. Further the clamping device may include handgrips for the user during the mounting and dismounting actions.

The present disclosure provides a user-transfer bench system. Further, the user transfer bench system may include a clamping device which may be configured for securing the user-transfer bench system on a bathtub. Further, the clamping device may be mechanically fastened to the bathtub. Further, the mechanical fastening of the clamping device with the bathtub may be further based on an adjustable screw-clamp corresponding to a screw fastening mechanism. Further, the user-transfer bench system may include a bench which may be configured for facilitating action performed by the user. Further, the bench may be mechanically coupled to the clamping device. Further, the bench may include one or more suction cups which may be configured for securing the user-transfer bench system to the bathtub. Further, the bench and the clamping face plates have a material lining which may be configured for protecting the bathtub from scrapes and scratches associated with the mechanical fastening of the clamping device with the bathtub.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a variation of the user-transfer bench system for bathtubs mechanically fastened to a bathtub, in accordance with some embodiments.

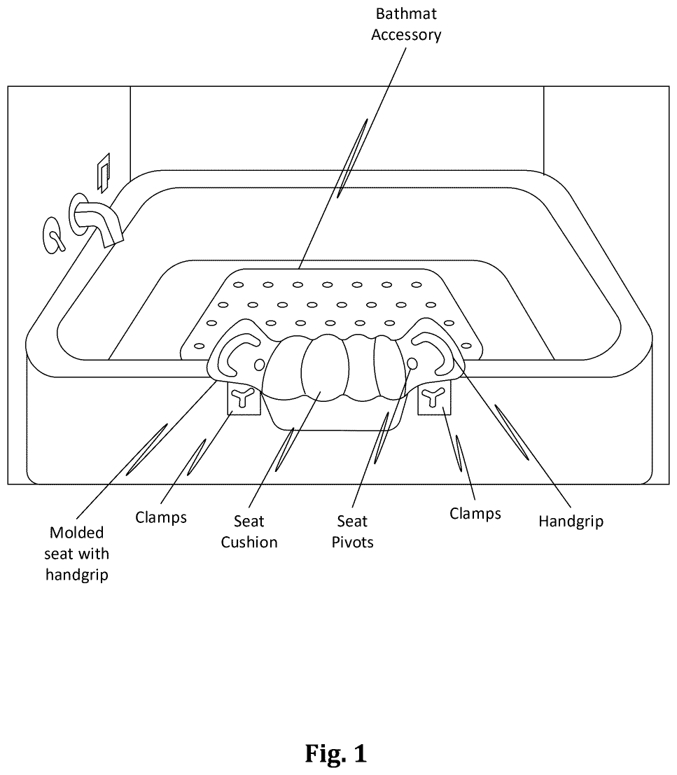

FIG. 2 is an illustration of an isometric view of a base of the user-transfer bench system for bathtubs, in accordance with some embodiments.

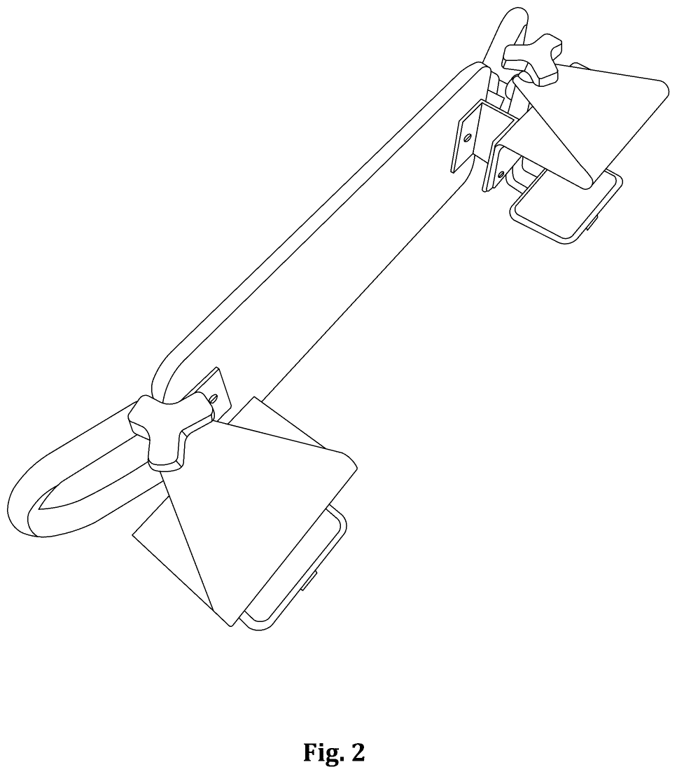

FIG. 3 is an illustration of an isometric view of the user-transfer bench system for bathtubs, in accordance with some embodiments.

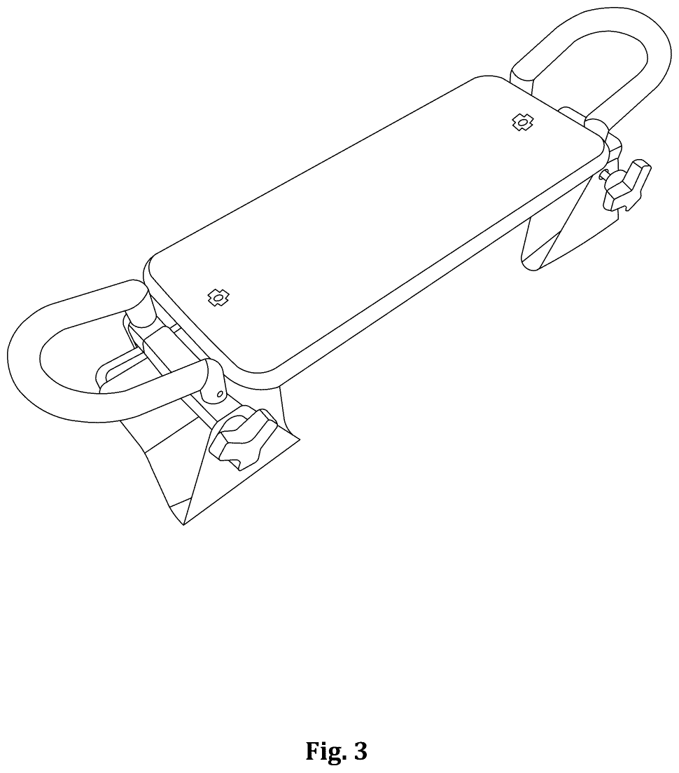

FIG. 4 is an illustration of a clamping mechanism of the user-transfer bench system for bathtubs, in accordance with some embodiments.

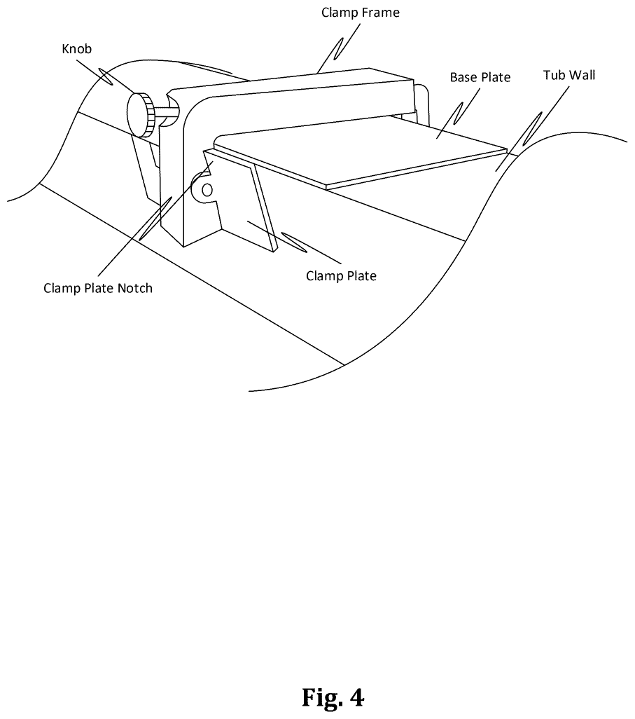

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

### Overview

The present disclosure discusses a novel bench seat that clamps over the side of a bathtub and assists users to safely enter and exit the bathtub. The bench has an integral handgrip formed at each end, a detachable padded seat cushion and a manually-adjustable clamp which is attached beneath each end of the seat. Each clamp is connected to the seat by a pivot pin or other such device so the clamp can swivel 360 degrees. The clamping face plates also swivel and rotate to accommodate tub walls with varied shapes and slopes. All bench and clamp surfaces which contact the bathtub are lined with material to protect the tub from scrapes and scratches. The bench is designed to work with either a left or right draining bathtub.

In some embodiments, the safest recommended way to exit a bathtub is to turn onto your hands and knees, hold onto the side of the bathtub and extend a leg out, over the tub, onto the bathroom floor; then, while continuing to hold the side of the tub, stand up with your weight on the leg outside of the tub and remove your other leg to stand out of the tub.

In some embodiments, this bench is designed to help you with the above mentioned procedure, not just when you exit the tub, but also when you enter the tub. To use this invention, hereinafter referred to as TubSaddle follow the following steps:
To enter the bathtub, face the TubSaddle and grab hold of the handgrip furthest from the drain.
Then straddle the TubSaddle and sit down on it facing the rear of the tub.
Bend your leg that is within the tub so your knee rests on the tub floor or is just above it.
Now, depending on which way you are facing, hold the handgrip with one hand and place your other hand on the bathtub floor to support yourself and slide off the TubSaddle onto your knee inside the tub, and roll over so you are sitting on your buttocks. (The movement is similar to dismounting from a saddle on a horse).
To exit the bathtub, you reverse the procedure. Turn over onto your hands and knees in the tub, grasp the handgrip and lift a leg out, over the TubSaddle and onto the bathroom floor; then pull yourself up onto the TubSaddle. Maintain your grasp on the handgrip and stand up with your weight on the leg outside the bathtub, and remove your other leg so you are safely standing out of the bathtub.

In some embodiments, the TubSaddle comes fully assembled.

In some embodiments, the present disclosure is a saddle-like bench seat that clamps to the wall of a bathtub with a pivoting clamp affixed beneath each end of the seat, and a handgrip on each end of the seat; providing a seat that you straddle and sit on as a means to safely enter and exiting the bathtub. This seat assists persons who want to recline on the floor of the bathtub to soak.

In some embodiments, the present disclosure may configure the clamp set-up on the outside tub wall to accommodate free standing tubs with sloping/slanted sides. Further, the plates may be notched in order to attain greater angles.

In some embodiments, the existing clamp attaches over the outer tub wall at 90 degrees and this configuration works for vertical sided tubs, but would not work for other tubs. Further, by cutting off the base plate under the bench and bending the existing channel housing down over the edge, we could use that channel housing as the arm for a new notched plate as shown.

In some embodiments, the present disclosure may use a rounded knob for ensuring user comfort.

In some embodiments, the user-transfer bench system may include a clamping device which may be configured for securing the user-transfer bench system on the bathtub. Further, the clamping device may be mechanically fastened to the bathtub. Further, the user-transfer bench system may include a bench which may be configured for facilitating mounting and dismounting actions performed by the user. Further, the bench may be mechanically coupled to the clamping device.

In some embodiments, the clamping device may be further configured for restricting a movement associated with the user-transfer bench system over the bathtub.

In some embodiments, the clamping device includes a handgrip which may be configured for provisioning a hand-held support for the user during the performance of the mounting and dismounting actions.

In some embodiments, the bench includes a swiveling device which may be configured for facilitating the mechanical coupling of the bench with the clamping device.

In some embodiments, the swiveling device includes a pivot pin. Further, the pivot pin further facilitates a swivel action associated with the clamping device in relation to the bench.

In some embodiments, the clamp may be further associated with a shape corresponding to the shape of the bathtub.

In some embodiments, the pivot pin further facilitates a swivel action associated with the clamping device in relation to the shape of the bathtub.

In some embodiments, the mechanical fastening of the clamping device with the bathtub may be based on a clamping face plate.

In some embodiments, the bench includes a bench-seat cushion which may be configured to provide comfortable seating for the user when mounting and dismounting the bench.

In some embodiments, the mounting action corresponds to an act of straddling the bench performed by the user.

In some embodiments, the clamping device includes two or more clamping devices. Further, each of the two or more clamping devices may be mechanically fastened to the bathtub.

In some embodiments, the bench includes one or more suction cups which may be configured for securing the user-transfer bench system to the bathtub.

In some embodiments, the mechanical fastening of the clamping device with the bathtub may be further based on an adjustable screw-clamp corresponding to a screw fastening mechanism.

In some embodiments, the bench and the clamping face plate include a material lining which may be configured to protect the bathtub from scrapes and scratches associated with the mechanical fastening of the clamping device with the bathtub.

In some embodiments, the clamping device may be further configured for facilitating an adjustment in a height associated with the user-transfer bench system for bathtubs.

In some embodiments, the clamping device may be further configured for facilitating an adjustment in an angle associated with the user-transfer bench system for bathtubs.

Accordingly, the user-transfer bench system for bathtubs may include a clamping device which may be configured for securing the user-transfer bench system for bathtubs. Further, the clamping device may be mechanically fastened to the bathtub. Further, the user-transfer bench system may include a bench which may be configured for facilitating mounting and dismounting actions performed by the user. Further, the bench may be mechanically coupled to the clamping device. Further, the clamping device may include a handgrip configured for provisioning a hand-held support for the user during the performance of the mounting and dismounting actions.

Accordingly, the user-transfer bench system for bathtubs may include a clamping device which may be configured for securing the user-transfer bench system for bathtubs. Further, the clamping device may be mechanically fastened to the bathtub. Further, the mechanical fastening of the clamping device with the bathtub may be further based on an adjustable screw clamp corresponding to a screw fastening mechanism. Further, the user-transfer bench system for bathtubs may include a bench which may be configured for facilitating mounting and dismounting actions performed by the user. Further, the bench may be mechanically coupled to the clamping device. Further, the bench may include one or more suction cups configured for securing the user transfer bench system to the bathtub. Further, both the bench and the clamping face plate have a material lining which may be configured for protecting the bathtub from scrapes and scratches associated with the mechanical fastening of the clamping device with the bathtub.

In some embodiments, the swivel action may be in a range of zero degrees and three hundred sixty degrees.

In some embodiments, the bench-seat cushion may be further configured to be detached from the bench.

The user-transfer bench system for bathtubs functions on bathtubs with the drain on either the right or left end of the bathtub.

In some embodiments, the bathtub includes a cushioned, non-slip bathmat fastened on the floor of the tub which cushions the user's knees and buttocks during the dismounting and mounting procedures.

In some embodiments, the bench includes bench-saddlebags which may be configured to store bathing accessories.

In some embodiments, the mechanical fastening of the clamping device with the bathtub may be based on a bracket with hook mechanism.

In some embodiments, the user-transfer bench system may further include a bathmat corresponding to an absorbent surface which may be configured for enhancing a surface friction associated with the bathtub.

In some embodiments, the clamping device includes a clamping-plate, a mechanical fastening device and a clamp-frame. Further, the clamping-plate may be configured for securing of the clamping device on the bathtub. Further, the mechanical fastening device may be configured for facilitating the mechanical fastening of the clamping-plate in relation to the bathtub.

In some embodiments, the clamping plate includes one or more of a top portion and a bottom portion. Further, the top portion corresponds to a top-section in relation to the clamping plate. Further, the bottom portion corresponds to a bottom-section in relation to the clamping plate.

In some embodiments, the clamping mechanism includes a notched-clamping plate configured to facilitate adjustments for bathtubs with sloping walls.

In some embodiments, the clamping plate may be further configured to be pivotally affixed to the clamp-frame. Further, the adjustment of the angle may be based on the pivotal affixment of the clamping plate.

In some embodiments, the angle of the clamping plate includes a right angle.

In some embodiments, the mechanical fastening device may comprise a rounded knob. Further, the rounded knob may be configured for facilitating the mechanical fastening.

Although the invention has been explained in relation to its preferred embodiment, it is to be understood that many other possible modifications and variations can be made without departing from the spirit and scope of the invention as hereinafter claimed.

1. A user-transfer bench system comprising:
a clamping device configured for securing the user-transfer bench system to a bathtub, wherein the clamping device is mechanically fastened to the bathtub; and
a bench configured for facilitating mounting and dismounting actions performed by the user, wherein the bench is mechanically coupled to the clamping device.

2. The user-transfer bench system for bathtubs of claim 1, wherein the clamping device is further configured for restricting a movement associated with the user-transfer bench system over the bathtub.

3. The user-transfer bench system for bathtubs of claim 1, wherein the clamping device comprises handgrips configured for provisioning a hand-held support for the user during the performance of the mounting and dismounting actions.

4. The user-transfer bench system for bathtubs of claim 1, wherein the bench comprises a swiveling device configured for facilitating the mechanical coupling of the bench with the clamping device.

5. The user-transfer bench system for bathtubs of claim 4, wherein the swiveling device comprises a pivot pin, wherein the pivot pin further facilitates a swivel action associated with the clamping device in relation to the bench.

6. The user-transfer bench system for bathtubs of claim 5, wherein the pivot pin further facilitates a swivel action associated with the clamping device in relation to the shape of the bathtub.

7. The user-transfer bench system for bathtubs of claim 1, wherein the mechanical fastening of the clamping device with the bathtub is based on a clamping face plate.

8. The user-transfer bench system for bathtubs of claim 1, wherein the bench comprises a bench-seat cushion configured to provide a comfortable seating for the user based on the mounting and dismounting actions.

9. The user-transfer bench system for bathtubs of claim 6, wherein the swivel action is in a range of zero degrees and three hundred sixty degrees.

10. The user-transfer bench system for bathtubs of claim 8, wherein the bench-seat cushion is further configured to be detached from the bench.

11. The user-transfer bench system for bathtubs of claim 1, wherein the mounting and dismounting actions correspond to an act of sitting performed by the user.

12. The user-transfer bench system for bathtubs of claim 1, wherein the clamping device comprises a plurality of clamping devices, wherein each of the plurality of clamping device is mechanically fastened to the bathtub.

13. The user-transfer bench system for bathtubs of claim 1, wherein the bench comprises one or more suction cups configured for securing the user-transfer bench system to the bathtub.

14. The user-transfer bench system for bathtubs of claim 8, wherein the mechanical fastening of the clamping device with the bathtub is further based on an adjustable screw-clamp corresponding to a screw fastening mechanism.

15. The user-transfer bench system for bathtubs of claim 8, wherein the bench and the clamping face plate comprises a material lining configured for protecting the bathtub from scrapes and scratches associated with the mechanical fastening of the clamping device with the bathtub.

16. The user-transfer bench system for bathtubs of claim 1, wherein the clamping device is further configured for facilitating an adjustment in a height associated with the user transfer bench system in relation to the bathtub.

17. The user-transfer bench system for bathtubs of claim 2, wherein the clamping device is further configured for facilitating an adjustment in an angle associated with the user-transfer bench system in relation to the bathtub.

18. The user-transfer bench system of claim 1, wherein the mechanical fastening of the clamping device with the bathtub is based on a bracket with hook mechanism.

19. A user-transfer bench system for bathtubs comprising:
a clamping device configured for securing the user-transfer bench system on a bathtub, wherein the clamping device is mechanically fastened to the bathtub; and
a bench configured for facilitating mounting and dismounting actions performed by the user, wherein the bench is mechanically coupled to the clamping device, wherein the clamping device comprises a handgrip configured for provisioning a hand-held support for the user during the performance of the mounting and dismounting action.

20. A user-transfer bench system for bathtubs comprising:
a clamping device configured for securing the user-transfer bench system on a bathtub, wherein the clamping device is mechanically fastened to the bathtub, wherein the mechanical fastening of the clamping device with the bathtub is further based on an adjustable screw-clamp corresponding to a screw fastening mechanism; and
a bench configured for facilitating mounting and dismounting actions performed by the user, wherein the bench is mechanically coupled to the clamping device, wherein the bench comprises one or more suction cups configured for securing the user-transfer bench system to the bathtub, wherein each of the bench and the clamping face plate comprises a material lining configured to protect the bathtub from scrapes and scratches associated with the mechanical fastening of the clamping device with the bathtub.
